(19) United States
(12) Patent Application Publication
(10) Pub. No.: US 2020/0265075 A1
(43) Pub. Date: Aug. 20, 2020

(54) KNOWLEDGE GRAPHING PLATFORM

(71) Applicant: Habla AI, Inc., San Jose, CA (US)

(72) Inventors: Thomas Knapp, San Jose, CA (US); Kelly Qian, Fremont, CA (US)

(21) Appl. No.: 16/280,737

(22) Filed: Feb. 20, 2019

(51) Int. Cl. G06F 16/34; G06F 16/38; G06F 16/31; G06F 16/335

(52) U.S. Cl. CPC G06F 16/34; G06F 16/335; G06F 16/316; G06F 16/38

(57) ABSTRACT

Knowledge graphing can include: generating a document selection interface that enables a user to browse at least one document storage service and select a set of documents stored on the document storage service for inclusion in a knowledge set; obtaining a set of meta-data for each document selected for the knowledge set from the respective document storage service; and generating a knowledge graph that spatially depicts a set of relationships among the documents of the knowledge set in terms of the meta-data.

### BACKGROUND

A group of individuals who share a common interest or who work toward a common goal can share knowledge via digital documents stored on document storage services. Examples of document storage services include cloud-based services such as Box, Dropbox, Google Drive, Sharepoint, etc.

For example, a team of individuals developing new products or services can share design documents, research reports, schedules, budgets, etc., via document storage services. Likewise, a group of old high school friends organizing a class reunion can share ideas, schedules, menus, locations, proposed dates, etc., via document storage services.

A document storage service can provide a web or app based interface that enables users to browse a list of stored documents. For example, a document storage service can provide an interface that provides a user with a list of document names, sizes, creation and modified dates, etc.

### SUMMARY

In general, in one aspect, the invention relates to a knowledge graphing platform. A knowledge graphing platform according to the invention can include: a document selection interface that enables a user to browse at least one document storage service and select a set of documents stored on the document storage service for inclusion in a knowledge set; and a knowledge grapher that obtains a set of meta-data for each document selected for the knowledge set from the respective document storage service and that generates a knowledge graph that spatially depicts a set of relationships among the documents of the knowledge set in terms of the meta-data.

In general, in another aspect, the invention relates to a method for knowledge graphing. The method can include: generating a document selection interface that enables a user to browse at least one document storage service and select a set of documents stored on the document storage service for inclusion in a knowledge set; obtaining a set of meta-data for each document selected for the knowledge set from the respective document storage service; and generating a knowledge graph that spatially depicts a set of relationships among the documents of the knowledge set in terms of the meta-data.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a knowledge graphing platform in one or more embodiments.

FIG. 2 shows a document selection interface and a knowledge grapher in one or more embodiments of a knowledge graphing platform.

FIG. 3 shows an example of a document selection interface in one or more embodiments.

FIG. 4 illustrates a set of meta-data obtained for a set of documents selected for a knowledge set.

FIG. 5 illustrates an example of a knowledge graph in one or more embodiments.

FIG. 6 is an example of a popup display in a knowledge graph in one or more embodiments.

FIG. 7 shows how a knowledge graph enables a user to zoom in on selected areas in one or more embodiments.

FIG. 8 shows an example of a document lineage graph in one or more embodiments.

FIG. 9 shows another example of a document lineage graph in one or more embodiments.

FIG. 10 illustrates a method for knowledge graphing in one or more embodiments.

FIG. 11 illustrates a computing system upon which portions of a knowledge graphing platform can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

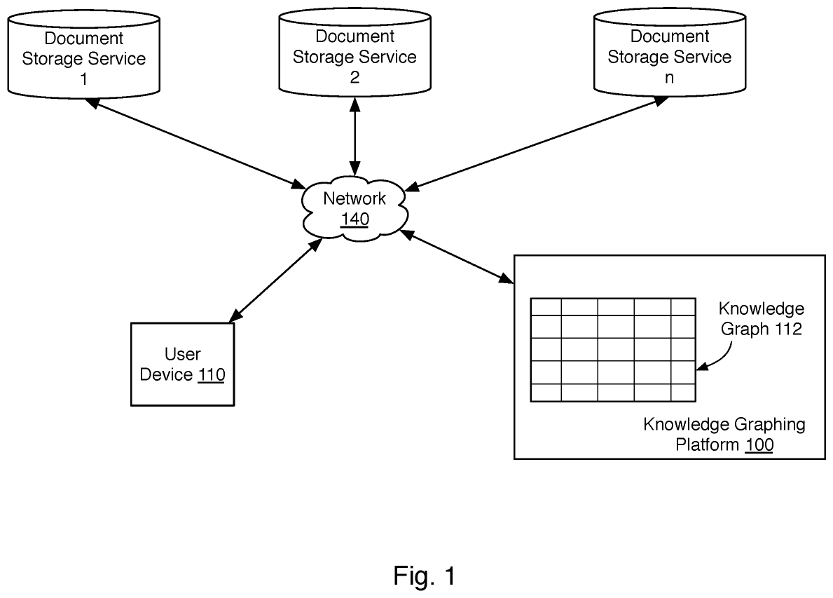

FIG. 1 illustrates a knowledge graphing platform 100 in one or more embodiments. The knowledge graphing platform 100 enables a user, e.g., via a user device 110, to access a knowledge graph 112 that spatially depicts a set of relationships among a set of documents stored on any one or more of a set of document storage services 1-n. The relationships spatially depicted in the knowledge graph 112 can be based on one or more document attributes, e.g., document size, creation date, modification dates, document content, etc.

In one or more embodiments, the knowledge graph 112 depicts an icon for each represented document against a background of a one, two, or higher, dimensional graph in which each axis of the graph represents a corresponding document attribute. For example, a horizontal axis of the knowledge graph 112 can depict document creation dates while a vertical axis of the knowledge graph 112 can depict document modification dates. In another example, a horizontal axis of the knowledge graph 112 can depict document access dates while a vertical axis of the knowledge graph 112 can depict document sizes.

In one or more embodiments, the knowledge graph 112 includes mechanisms for zooming in and out of the knowledge graph 112. For example, a user can zoom in to an area of the knowledge graph 112 to obtain higher resolution in the spatial depictions of dates, sizes, etc., or zoom out spatially to include more document icons with less resolution on dates, sizes, etc.

In one or more embodiments, the knowledge graph 112 includes mechanisms that enable a user to individually select documents depicted in the knowledge graph 112 and view a set of document details for the selected documents. For example, a user can select, e.g., via click, touch input, etc., a document icon depicted in the knowledge graph 112 to obtain a popup display of information pertaining to the selected document, e.g., document name, size, creation, modification dates, owners, credentials, where it is stored, etc.

In one or more embodiments, the knowledge graph 112 includes mechanisms that enable a user to filter the documents depicted in the knowledge graph 112. For example, the knowledge graph 112 can include user interface elements that enable a user to filter the documents depicted in the knowledge graph 112 based on where the documents are stored, document size, document creation, modification dates, or based on the content of the documents, e.g., keywords, word counts, semantic analyses, etc.

In one or more embodiments, the knowledge graph 112 provides access to a depiction of a lineage associated with one or more of the documents depicted in the knowledge graph 112. For example, when a user selects, e.g., via click, touch input, etc., a document icon depicted in the knowledge graph 112, the knowledge graphing platform 100 can generate a visual depiction of a lineage for the selected document that spatially depicts at least one aspect of the document. For example, a depiction of a lineage can spatially depict an access history for the selected document, e.g., when accessed and by who, etc.

The documents depicted in the knowledge graph 112 can include any type of digital documents in any format, e.g., industry standard formats. Examples of documents that can be represented in the knowledge graph 112 include text files, e.g., word files, image files, e.g., jpeg, tiff, etc., PDF files, video/movie files, data files, planning/organization files, financial files, etc.

The document storage services 1-n can include any document storage service such as a so-called cloud-based service, e.g., Dropbox, Box, Sharepoint, Google Drive, etc., accessible via a network 140, using e.g., Internet protocols. The documents depicted in the knowledge graph 112 can be distributed across any selection and arrangement of the document storage services 1-n.

The user device 110 can be any computing device or other device capable of providing user interface functions. Examples include computers such as desktop computers, laptop computers, mobile devices such as tablets, smartphones, etc., as well as wearable devices. For example, a computing device can run a web browser application program to access the knowledge graph 112, a mobile device can run an app adapted for accessing the knowledge graphing platform 100 to access the knowledge graph 112, etc.

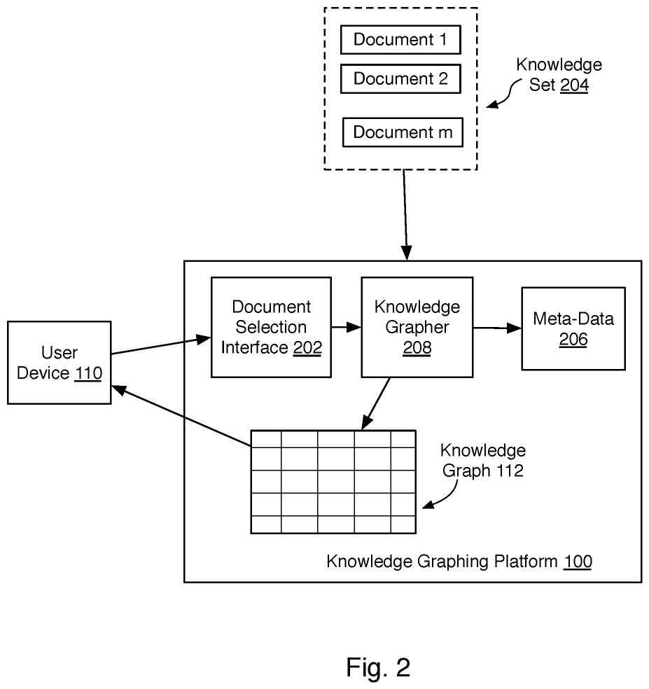

FIG. 2 shows a document selection interface 202 and a knowledge grapher 208 in one or more embodiments of the knowledge graphing platform 100. The document selection interface 202 enables a user to select a set of documents 1-m stored on the document storage services 1-n for inclusion in a knowledge set 204 and the knowledge grapher 208 generates the knowledge graph 112 based on the documents 1-m of the knowledge set 204.

In one or more embodiments, the document selection interface 202 enables a user via the user device 110 to browse the document storage services 1-n and to individually select browsed documents for inclusion in the knowledge set 204. For example, a user having an account on the document storage service 1 can enter their credentials for their account on the document storage service 1 via the document selection interface 202 and the knowledge graphing platform 100 can use a public API of the document storage service 1 to obtain a list of documents belonging to the user. The document selection interface 202 can depict the list of available documents to the user along with user interface elements that enable the user to select individual documents for inclusion in the knowledge set 204.

The knowledge grapher 208 obtains a set of meta-data 206 for the documents 1-m identified in the knowledge set 204 from the document storage services 1-n and then generates the knowledge graph 112 based on the meta-data 206. The knowledge grapher 208 can obtain the meta-data 206 via, e.g., public APIs of the document storage service 1-n using the appropriate user credentials.

The meta-data 206 for the documents 1-m can include document names, document types, document creation parameters, document ownership parameters, document modification parameters, document size parameters, document sharing information, document version parameters, keywords, etc. The meta-data 206 can include identifications of the document storage services 1-n where the respective documents 1-m are stored along corresponding credentials for accessing the document storage services 1-n.

In some embodiments, the meta-data 206 can include information pertaining to the content of the documents 1-m. Examples include word counts, counts of occurrences of keywords, phrases, etc., metrics pertaining to semantic analyses of the contents of the documents 1-m, etc.

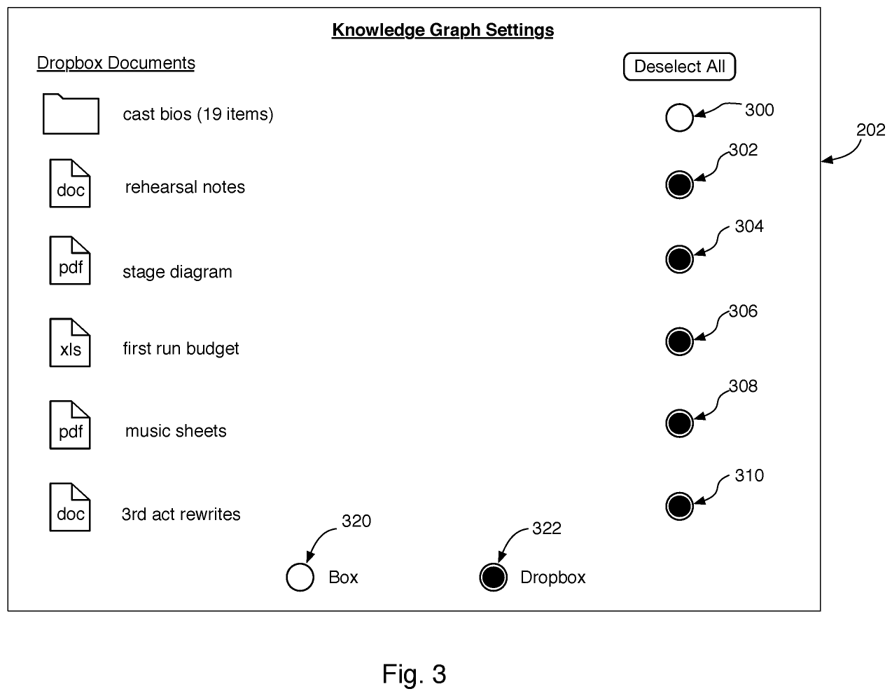

FIG. 3 shows an example of the document selection interface 202 in one or more embodiments. In this example, the document selection interface 202 enables a user, a struggling actor of a group of struggling actors who are putting on a play in an out of the way small theater, to select documents for a knowledge set to be used in sharing production information among cast and crew. The document selection interface 202 in this example includes a pair of user interface elements 320 and 322 that enable a user to select among a corresponding pair of document storage services, Box and Dropbox, respectively, where production documents are stored.

In this example, the struggling actor selects Dropbox via the user interface element 322 and, in response, the knowledge graphing platform 100 accesses Dropbox using the credentials provided by the struggling actor and obtains a list of documents and folders accessible to the struggling actor on Dropbox. The knowledge graphing platform 100 depicts the available Dropbox documents in the document selection interface 202 along with a set of respective selector elements 300-310. For example, the selector element 300 enables the struggling actor to select or deselect the “cast bios” folder and the selector element 302 enables the struggling actor to select or deselect the “stage diagram” pdf document. In this example, the struggling actor has selected “rehearsal notes”, “stage diagram”, “first run budget”, “music sheets”, and “3rd act rewrites” for inclusion in the knowledge set 204.

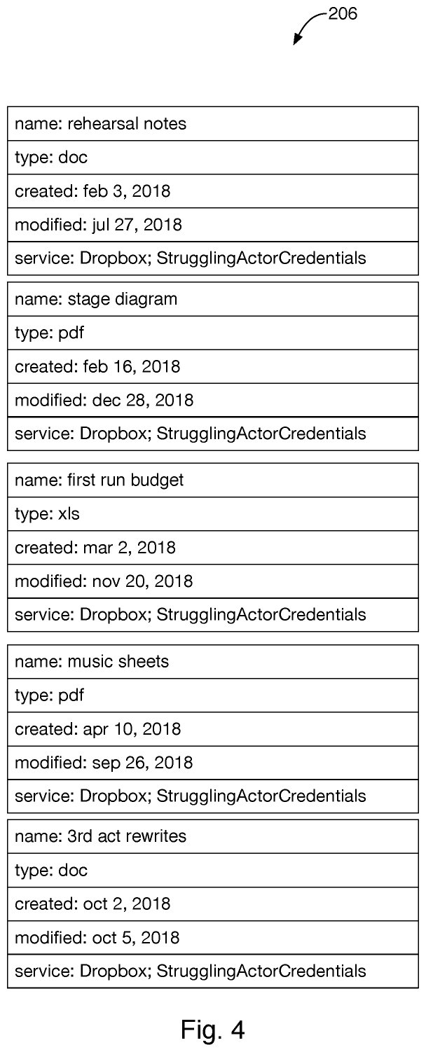

FIG. 4 illustrates the meta-data 206 obtained by the knowledge grapher 208 in response to the document selections shown in FIG. 3. For example, the meta-data 206 for the word document “rehearsal notes” indicates it was created on February 3 and modified on July 27 and the meta-data 206 for the pdf document “stage diagram” indicates it was created on February 16 and modified on December 28.

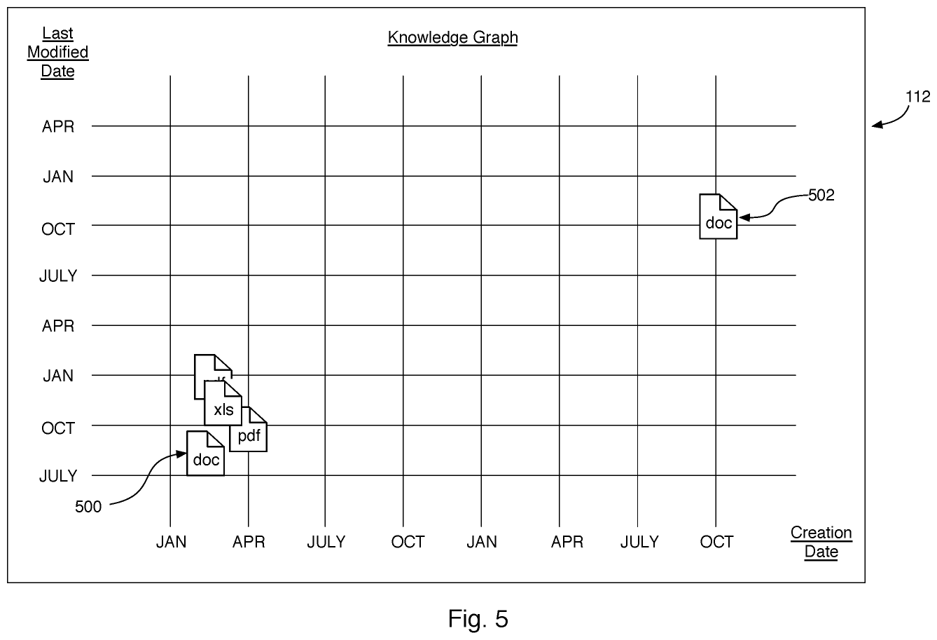

FIG. 5 illustrates the knowledge graph 112 generated by the knowledge grapher 208 in response to the meta-data 206 shown in FIG. 4. In this example, the knowledge graph 112 includes a horizontal axis depicting document creation dates and a vertical axis depicting document last modified dates.

The documents selected in the knowledge set 204 are depicted in the knowledge graph 112 in this example using icons, e.g., industry standard icons, indicating document type. For example, an icon 500 at the bottom-left of the knowledge graph 112 depicts the word document “rehearsal notes” while an icon 502 top-right depicts the word document “3rd act rewrites”.

The knowledge grapher 208 positions the icons representing the documents selected for the knowledge set 204 by aligning the icons to the horizontal and vertical axes of the knowledge graph 112 based on the creation and modification dates listed in the meta-data 206. For example, the icon 500 for the word document “rehearsal notes” aligns to a creation date of “feb 3” and a modification date of “jul 27” while the icon 502 for the word documents “3rd act rewrites” aligns to a creation date of “oct 2” and a modification date of “oct 5”.

A struggling actor viewing the knowledge graph 112 shown in FIG. 5 can discern information pertaining to their project from the spatial distribution of document icons. For example, the spatial distribution of document icons indicates a relatively high amount of activity for their play at the beginning of the year but a gap in activity until the 3rd act rewrites become available in October.

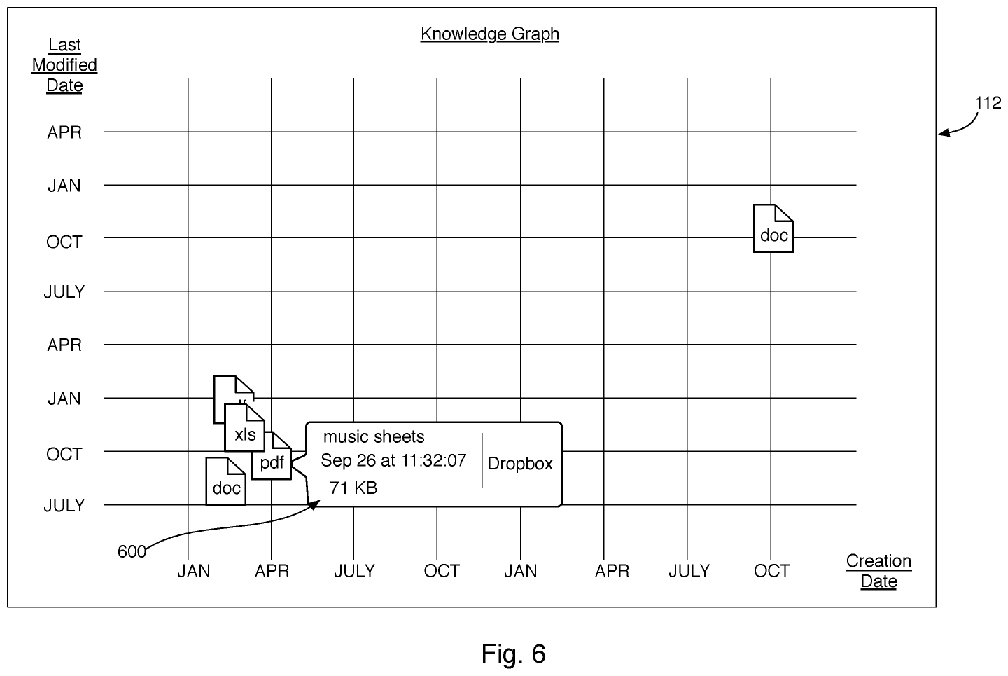

FIG. 6 illustrates a popup display 600 in the knowledge graph 112 that provides additional information, e.g., modified date/time and document size, storage location, for a selected icon which in this example is the “music sheets” pdf document. The information presented in the popup display 600 can include any of the information in the meta-data 206 for the music sheets pdf document. In some embodiments, the user popup display 600 can display the appropriate credentials for accessing the music sheets pdf document on Dropbox so that the user can cut and past the credentials and send the credentials to another user in a message.

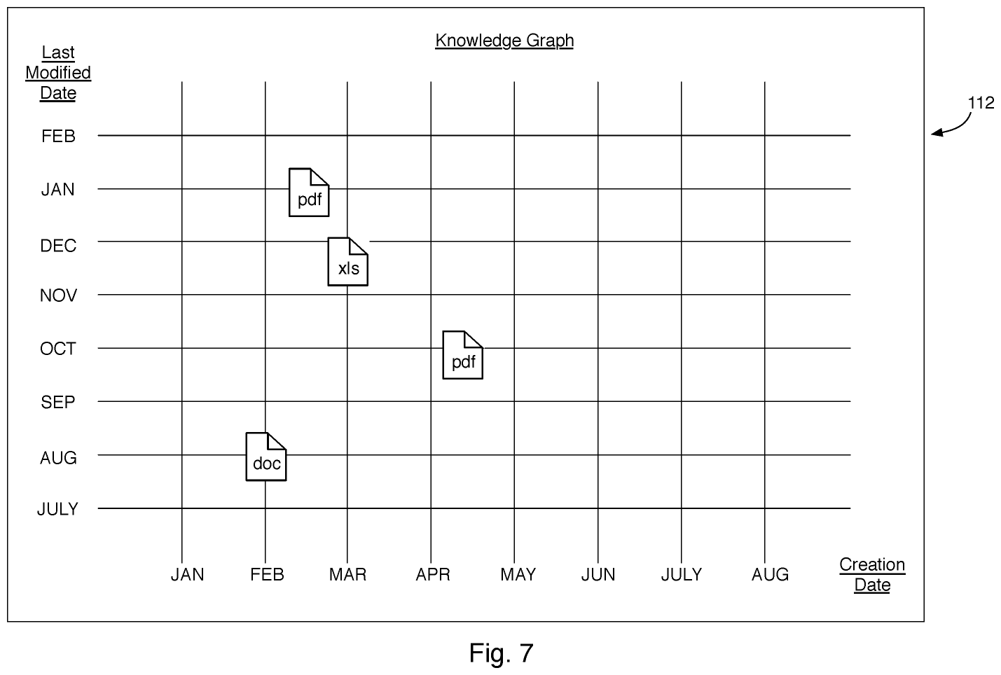

FIG. 7 shows how the knowledge graph 112 enables a user to zoom in on selected areas. In this example, a struggling actor has zoomed in on the cluster of documents depicted in the bottom-left of the knowledge graph 112 of FIG. 5. The zoom in provides improved resolution in depicting creation date and last modified dates for the rehearsal notes, stage diagram, first run budget, and music sheets documents while the 3rd act rewrites document has moved out of view.

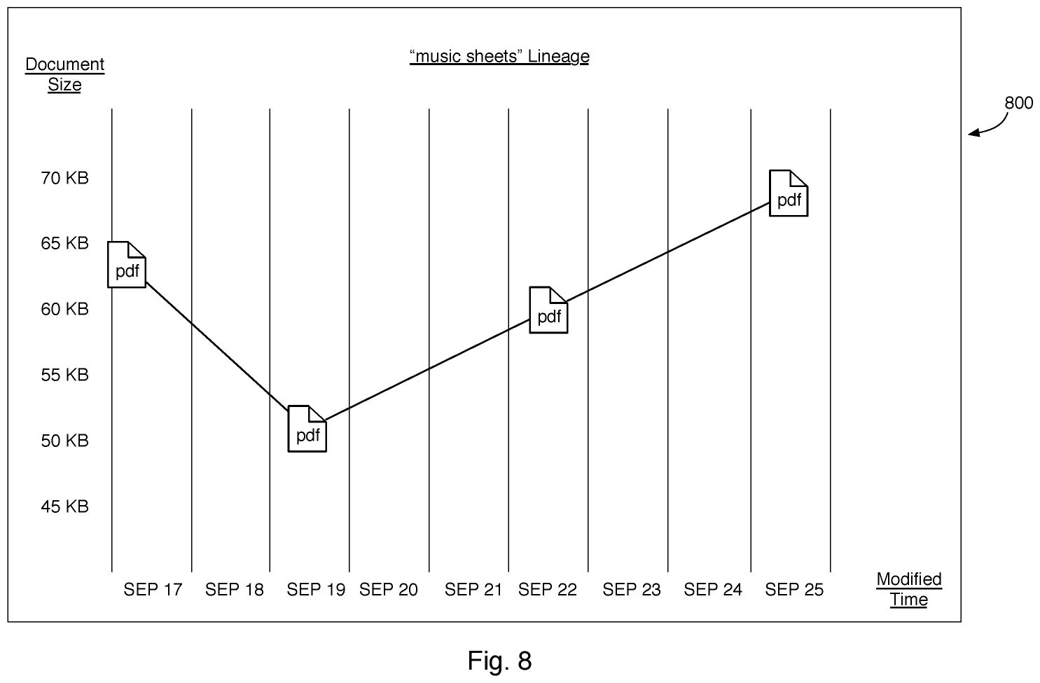

FIG. 8 shows a document lineage graph 800 in one or more embodiments. In this example, the document lineage graph 800 depicts modifications made to the “music sheets” pdf doc of the knowledge set 204. The horizontal axis of the document lineage graph 800 depicts modification dates and the vertical axis depicts document size. The four modification depicted in the document lineage graph 800 along with resulting document sizes are those recorded in the meta-data 206 for the music sheets pdf document.

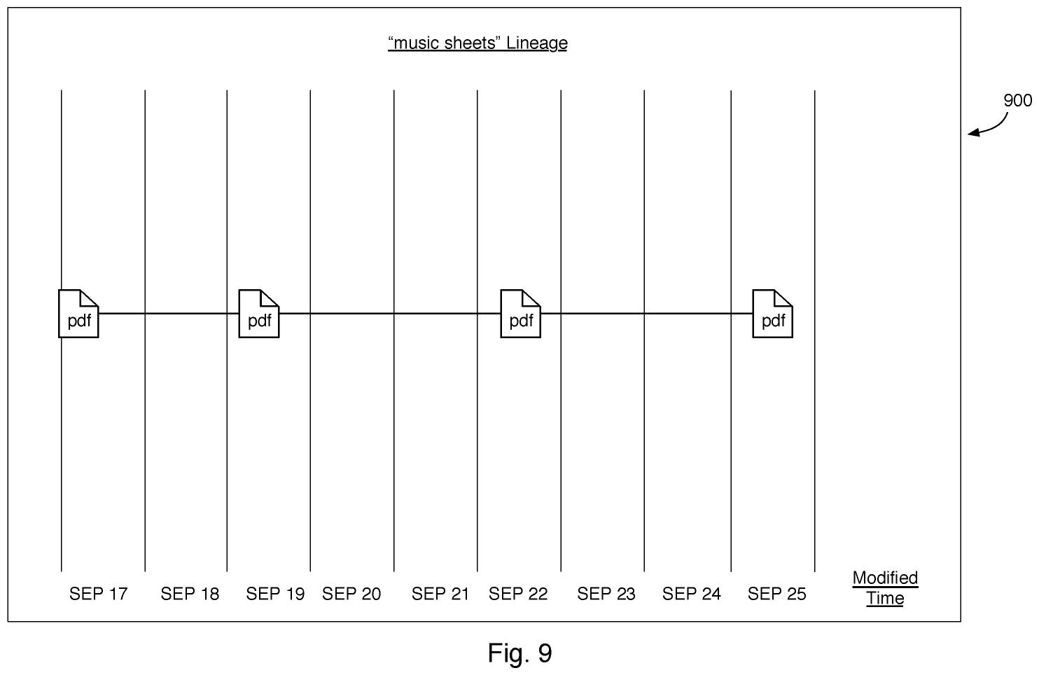

FIG. 9 shows a document lineage graph 900 depicting modifications made to the music sheets pdf doc in the knowledge set 204 in one or more other embodiments. In this example, only modification dates are depicted, and along the horizontal axis of the document lineage graph 900.

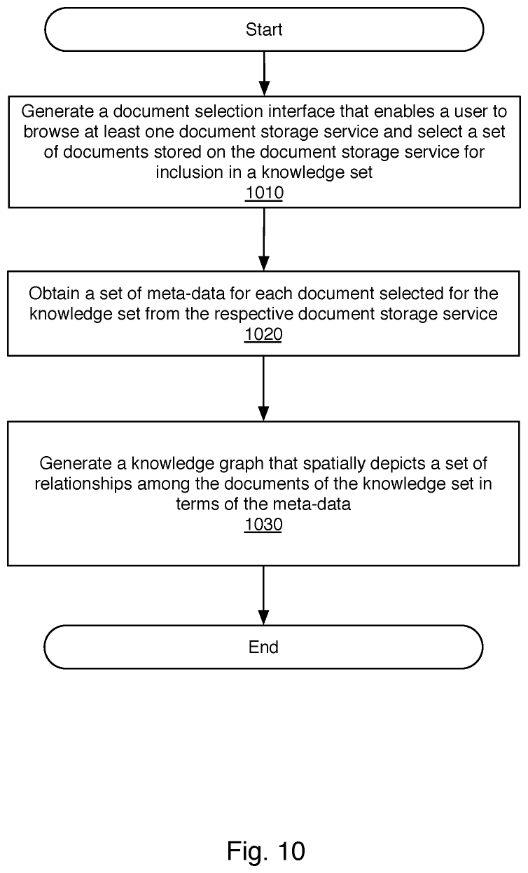

FIG. 10 illustrates a method for knowledge graphing in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 10 should not be construed as limiting the scope of the invention.

At step 1010, a document selection interface is generated that enables a user to browse at least one document storage service and select a set of documents stored on the document storage service for inclusion in a knowledge set. The document selection interface can be accessible via a network using a computing device of the user.

At step 1020, a set of meta-data is obtained for each document selected for the knowledge set from the respective document storage service. The meta-data can be obtained using a public API of a document storage service using a set of credentials of the user for accessing the document storage service.

At step 1030, a knowledge graph is generated that spatially depicts a set of relationships among the documents of the knowledge set in terms of the meta-data. The relationships depicted can be based on any combination of the meta-data for the documents. A spatial depiction can be based on the positioning of icons representing the documents along one or more axes of the knowledge graph.

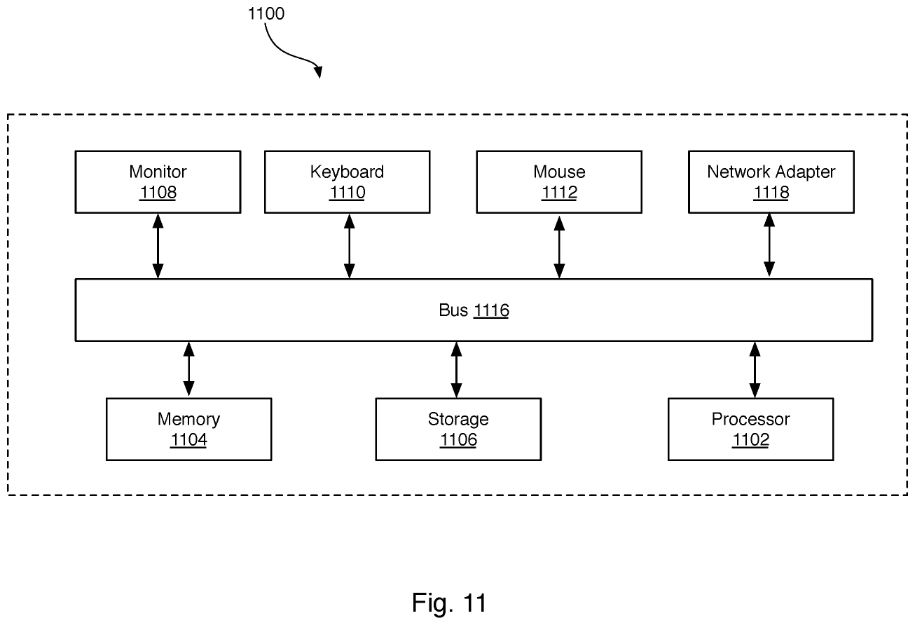

FIG. 11 illustrates a computing system 1100 upon which portions of the knowledge graphing platform 100 can be implemented. The computing system 1100 includes one or more computer processor(s) 1102, associated memory 1104 (e.g., random access memory (RAM), cache memory, flash memory, etc.), one or more storage device(s) 1106 (e.g., a hard disk, an optical drive such as a compact disk (CD) drive or digital versatile disk (DVD) drive, a flash memory stick, etc.), a bus 1116, and numerous other elements and functionalities.

The computer processor(s) 1102 may be an integrated circuit for processing instructions. For example, the computer processor(s) may be one or more cores or micro-cores of a processor. The computing system 1100 may also include one or more input device(s), e.g., a touchscreen, keyboard 1110, mouse 1112, microphone, touchpad, electronic pen, or any other type of input device. Further, the computing system 1100 may include one or more monitor device(s) 1108, such as a screen (e.g., a liquid crystal display (LCD), a plasma display, touchscreen, cathode ray tube (CRT) monitor, projector, or other display device), external storage, input for an electric instrument, or any other output device. The computing system 1100 may be connected to, e.g., a local area network (LAN), a wide area network (WAN) such as the Internet, mobile network, or any other type of network) via a network adapter 1118.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A knowledge graphing platform, comprising:
a document selection interface that enables a user to browse at least one document storage service and select a set of documents stored on the document storage service for inclusion in a knowledge set; and
a knowledge grapher that obtains a set of meta-data for each document selected for the knowledge set from the respective document storage service and that generates a knowledge graph that spatially depicts a set of relationships among the documents of the knowledge set in terms of the meta-data.

2. The knowledge graphing platform of claim 1, wherein the knowledge graph includes a mechanism for zooming in and out of an area of the knowledge graph selected by the user.

3. The knowledge graphing platform of claim 1, wherein the knowledge graph enables the user to view a set of document details of at least one of the documents depicted in the knowledge graph based on the respective meta-data.

4. The knowledge graphing platform of claim 1, wherein the knowledge graph includes a mechanism that enables the user to filter the documents depicted in the knowledge graph based on one or more aspects of the meta-data.

5. The knowledge graphing platform of claim 1, wherein the knowledge graph includes at least two dimensions each spatially depicting a corresponding aspect of the meta-data.

6. The knowledge graphing platform of claim 1, wherein the knowledge grapher generates a visual depiction of a lineage associated with at least one of the documents depicted in the knowledge graph.

7. The knowledge graphing platform of claim 6, wherein the visual depiction of the lineage spatially depicts at least one aspect of the meta-data of document.

8. The knowledge graphing platform of claim 6, wherein the visual depiction of the lineage spatially depicts at least two aspects of the meta-data of document.

9. A method for knowledge graphing, comprising:
generating a document selection interface that enables a user to browse at least one document storage service and select a set of documents stored on the document storage service for inclusion in a knowledge set;
obtaining a set of meta-data for each document selected for the knowledge set from the respective document storage service; and
generating a knowledge graph that spatially depicts a set of relationships among the documents of the knowledge set in terms of the meta-data.

10. The method of claim 9, wherein generating a knowledge graph includes providing a mechanism for zooming in and out of an area of the knowledge graph selected by the user.

11. The method of claim 9, wherein generating a knowledge graph includes providing a mechanism for the user to view a set of document details of at least one of the documents depicted in the knowledge graph based on the respective meta-data.

12. The method of claim 9, wherein generating a knowledge graph includes providing a mechanism that enables the user to filter the documents depicted in the knowledge graph based on one or more aspects of the meta-data.

13. The method of claim 9, wherein generating a knowledge graph includes generating a knowledge graph that includes at least two dimensions each spatially depicting a corresponding aspect of the meta-data.

14. The method of claim 9, wherein generating a knowledge graph includes providing a visual depiction of a lineage associated with at least one of the documents depicted in the knowledge graph.

15. The method of claim 14, wherein providing a visual depiction of a lineage includes depicting at least one aspect of the meta-data of document.

16. The method of claim 14 wherein providing a visual depiction of a lineage includes depicting at least two aspects of the meta-data of document.
